(19) United States
(12) Patent Application Publication
(10) Pub. No.: US 2022/0300869 A1
(43) Pub. Date: Sep. 22, 2022

(54) INTELLIGENT AIRFARE PATTERN PREDICTION

(71) Applicant: SAP SE, Walldorf (DE)

(72) Inventor: Suresh Kumar Raju, Singapore (SG)

(21) Appl. No.: 17/207,952

(22) Filed: Mar. 22, 2021

(51) Int. Cl. G06Q 10/06; G06N 20/00

(52) U.S. Cl. CPC G06Q 10/067; G06N 20/00

(57) ABSTRACT

Implementations include periodically receiving itinerary data representative of routes, the itinerary data including date, price, and route, for each period and each route: encoding a first portion of the itinerary data using label encoding to provide encoded data, the first portion of the itinerary data including letters, the encoded data including numbers and being absent of letters, converting a second portion of the itinerary data using a mapping to provide converted data, the converted data including a number, training a ML model for a respective route using the encoded data and the converted data, receiving a prediction request including a route and a departure date, retrieving a ML model associated with the route, and generating a prediction result by processing the route and the departure date through the ML model, the prediction result including a set of price-day pairs.

### BACKGROUND

Enterprises continuously seek to improve and gain efficiencies in their operations. To this end, enterprises employ software systems to support execution of operations. Software systems can be used to automate tasks and/or provide tools to improve operational efficiencies and reduce costs. For example, there is an ongoing shift to so-called intelligent enterprise, which includes supporting enterprise operations using machine learning (ML) systems. That is, ML models are used to automate tasks and/or provide information to gain efficiencies in enterprise operations and reduce costs.

In enterprise operations, travel can be a significant cost as travel is often an essential part of people's jobs. Enterprises aim to reduce cost by seeking low cost travel options. However, and for various reasons, travel costs often end up being higher than expected. For example, delays in booking travel often result in increased costs. In most cases, airfare is a significant contributor to the overall cost of a travel itinerary. To this end, enterprises employ tactics in an effort to reduce the cost spent on airfare. For example, enterprises seek early bookings, limit travel to budget airlines, and/or employ internal or external travel agents to assist in travel arrangements.

In the intelligent enterprise context, software systems could be leveraged to reduce cost in airfare that an enterprise expends. For example, some software systems provide price histories and/or price ranges for airfare relative to a current price to enable users to determine the current price relative to past prices. However, because such software systems are backward looking, they are not that helpful in assisting users in determining when to book to achieve the lowest price. Although more complex software systems could be leveraged, such as those employing ML, integrating such software systems in the airfare context presents numerous technical hurdles.

### SUMMARY

Implementations of the present disclosure are directed to an intelligent airfare prediction platform to forecast price variations in airfare. More particularly, implementations of the present disclosure are directed to an intelligent airfare prediction platform that provides a set of machine learning (ML) models based on unique characteristics of individual routes. As described in further detail herein, each ML model in the set of ML models results from data extraction, data preparation, feature engineering, and training, in a manner that overcomes technical hurdles that are presented in the context of airfare forecasting.

In some implementations, actions include periodically receiving itinerary data representative of routes in a set of routes, the itinerary data including date data, price data, and route data, for each period and each route in the set of routes: encoding at least a first portion of the itinerary data using label encoding to provide encoded data, the first portion of the itinerary data including letters, the encoded data including one or more numbers and being absent of letters, converting at least a second portion of the itinerary data using a mapping to provide converted data, the converted data including a number, training a ML model for a respective route using the encoded data and the converted data, and storing the ML model in computer-readable memory, the set of ML models including the ML model, receiving a prediction request including data representative of a route and a departure date, retrieving a ML model associated with the route from the computer-readable memory, and generating a prediction result by processing at least a portion of the data representative of the route and the departure date through the ML model, the prediction result including a set of price-day pairs, each price-day pair including a price of airfare and a number of days before the departure date. Other implementations of this aspect include corresponding systems, apparatus, and computer programs, configured to perform the actions of the methods, encoded on computer storage devices.

These and other implementations can each optionally include one or more of the following features: encoding at least a first portion of the itinerary data using label encoding to provide encoded data includes mapping string values to numerical values, the string values including one or more of names of airlines, a source, a destination, and carrier codes; the mapping includes a set of time ranges, each time range associated with a numerical value, and converting at least a second portion of the itinerary data using a mapping to provide converted data comprises, for each time in the second portion: mapping the time to a time range, identifying a numerical value associated with the time range, and including the numerical value in the converted data; actions further include converting each null value in the itinerary data to zero; the itinerary data is representative of a selected number of days before a departure date associated with each route in the set of routes; each ML model in the set of ML models is a random forest regression model that is trained using a root mean square error (RMSE) function; and the itinerary data is retrieved through one or more application programming interfaces (APIs), each API associated with a respective airline.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts a conceptual architecture in accordance with implementations of the present disclosure.

FIG. 3 depicts an example user interface (UI) in accordance with implementations of the present disclosure.

FIG. 4 depicts an example graph representing a set of predicted prices of airfare for a target flight in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to an intelligent airfare prediction platform to forecast price variations in airfare. More particularly, implementations of the present disclosure are directed to an intelligent airfare prediction platform that provides a set of machine learning (ML) models based on unique characteristics of individual routes. As described in further detail herein, each ML model in the set of ML models results from data extraction, data preparation, feature engineering, and training, in a manner that overcomes technical hurdles that arise in the context of airfare forecasting.

Implementations can include actions of periodically receiving itinerary data representative of routes in a set of routes, the itinerary data including date data, price data, and route data, for each period and each route in the set of routes: encoding at least a first portion of the itinerary data using label encoding to provide encoded data, the first portion of the itinerary data including letters, the encoded data including one or more numbers and being absent of letters, converting at least a second portion of the itinerary data using a mapping to provide converted data, the converted data including a number, training a ML model for a respective route using the encoded data and the converted data, and storing the ML model in computer-readable memory, the set of ML models including the ML model, receiving a prediction request including data representative of a route and a departure date, retrieving a ML model associated with the route from the computer-readable memory, and generating a prediction result by processing at least a portion of the data representative of the route and the departure date through the ML model, the prediction result including a set of price-day pairs, each price-day pair including a price of airfare and a number of days before the departure date.

To provide further context for implementations of the present disclosure, and as introduced above, enterprises continuously seek to improve and gain efficiencies in their operations. To this end, enterprises employ software systems to support execution of operations. Software systems can be used to automate tasks and/or provide tools to improve operational efficiencies and conserve costs. For example, there is an ongoing shift to so-called intelligent enterprise, which includes supporting enterprise operations using machine learning (ML) systems. That is, ML models are used to automate tasks and/or provide information to gain efficiencies in enterprise operations and reduce costs.

In enterprise operations, travel can be a significant cost as travel is often an essential part of people's jobs. Enterprises aim to reduce cost by seeking low cost travel options. However, and for various reasons, travel costs often end up being higher than expected. For example, delays in booking travel often results in increased costs. In most cases, airfare is a significant contributor to the overall cost of a travel itinerary. To this end, enterprises employ tactics in an effort to reduce the cost of airfare. For example, enterprises seek early bookings, limit travel to budget airlines, and/or employ internal or external travel agents to assist in travel arrangements.

In further detail, a significant obstacle for an enterprise to reduce the cost of airfare is that there is little direction in determining the right time to book a ticket for a target flight to achieve the lowest cost. In the process of preparing an itinerary, the tickets are often bought without clear insight into changes in the cost of the airfare over time. Currently, flight booking systems are absent guidance for users to know when to book a flight to achieve the lowest cost airfare for the particular itinerary (e.g., book today or book X days from today). This is at least partially because each route (e.g., between departure airport and arrival airport) has a unique cost pattern to its booking, which is often unobserved. For example, while some booking systems are able to provide a price history of the airfare of a target flight, they are absent providing knowledge regarding the possible price variations of airfares between a current date and a forthcoming departure date of the flight.

It can also be noted that, prices of airfare and price variations thereof are too complex for users to competently predict, as price is controlled by complex, computer-implemented algorithms that can adjust prices on a daily basis, if not more frequently. For example, airfares of different airlines and different routes may have different patterns of price variation. In some instances, base prices for the same route with different airlines can be different. In some instances, and even for the same airline, seasonal pricing is provided for different destinations. In some instances, price variation is seen even for flights with the same airline and the same destination, but with different departure times. For example, passengers tend to purchase night flights for long-haul flights, such that daytime is not spent on travel. Also, passengers tend to purchase tickets for work on weekdays, and tend to purchase tickets for vacation during weekends or holidays. If the destination is known as a tourism spot or a business capital, price variations might be reflected in the departure date selected by the passenger. Further, the density of flights of the same routes impacts the price pattern. That is, if there are a significant number of flights from a departure airport to the same arrival airport, the price variation in airfare might be small as compared to a fewer number of flights. Also, multiple options of routes to the same destination may also have different impact with respect to short-haul flights or long-haul flights. For example, passengers tend to accept multiple stops in a long-haul itinerary, but avoid multiple stops in a short-haul itinerary.

In the intelligent enterprise context, software systems could be leveraged to reduce cost in airfare that an enterprise expends. For example, some software systems provide price histories and/or price ranges for airfare relative to a current price to enable users to determine the current price relative to past prices. However, because such software systems are backward looking, they are not that helpful in assisting users in determining when to book to achieve the lowest price. Although more complex software systems could be leveraged, such as those employing ML, integrating such software systems in the airfare context presents numerous technical hurdles. For example, and as discussed above, variations in price patterns for individual routes depend on such a numerosity of factors that leveraging ML in this context presents numerous technical hurdles that solutions must be provided for.

In view of the above context, and as introduced above, implementations of the present disclosure provide an intelligent airfare prediction platform that provides a set of ML models based on unique characteristics of individual routes. As described in further detail herein, each ML model in the set of ML models results from data extraction, data preparation, feature engineering, and training, in a manner that overcomes technical hurdles in the context of airfare forecasting. In some implementations, data extraction and training of individual ML models is performed on a periodic basis (e.g., daily) for each route in a set of routes (e.g., between a departure airport and an arrival airport). In some examples, a ML model is selected for a particular route and provides output indicating a forecast of a cost of airfare for the route from a target date (e.g., current date) to a departure date. In some examples, the output also indicates historical cost of the airfare.

In some implementations, each ML model of the set of ML models corresponds to one destination (assuming the source location of all the routes are the same). The data regarding airfares of all of the routes to this destination will be extracted periodically (e.g., daily), so the corresponding ML model can be trained accordingly. In some examples, each ML model in the set of ML models is also specific to one or more other factors, such as routes and airlines, or a combination of factors (e.g., weekend of destination A, weekday of destination B . . . etc.), the disclosure is not limited thereto.

Implementations of the present disclosure are described in further detail with reference to example use cases. It is contemplated, however, that implementations of the present disclosure can be realized in any appropriate use case.

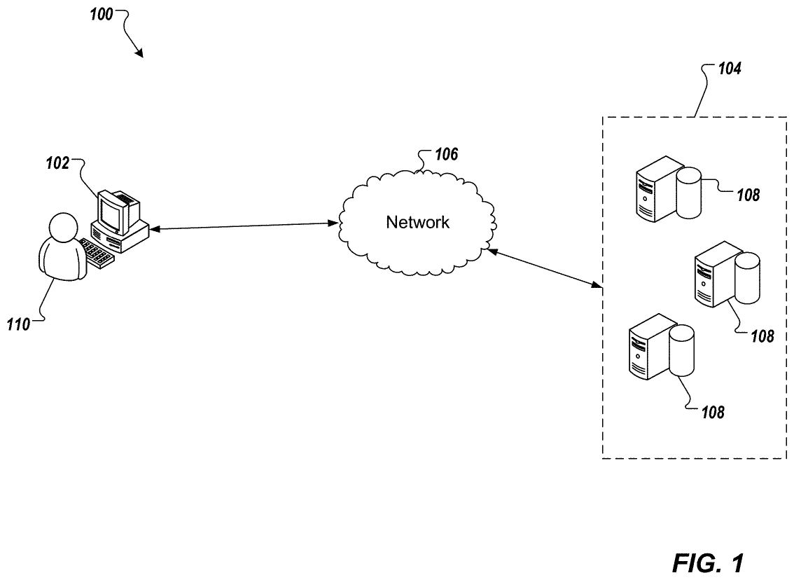

FIG. 1 depicts an example architecture 100 in accordance with implementations of the present disclosure. In the depicted example, the example architecture 100 includes a client device 102, a server system 104, and a network 106. The server system 104 includes one or more server devices 108. In the depicted example, respective a user 110 interacts with the client device 102. In an example context, a user 110 can include a user, who interacts with an application that is hosted by the server system 104 (e.g., a flight booking application).

In some examples, the client device 102 can communicate with one or more of the server devices 108 over the network 106. In some examples, the client device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, each server device 108 includes at least one server and at least one data store. In the example of FIG. 1, the server devices 108 are intended to represent various forms of servers including, but not limited to a web server, an application server, a proxy server, a network server, and/or a server pool. In general, server systems accept requests for application services and provides such services to any number of client devices (e.g., the client device 102) over the network 106.

In some implementations, one or more data stores of the server system 104 store one or more databases. In some examples, a database can be provided as an in-memory database. In some examples, an in-memory database is a database management system that uses main memory for data storage. In some examples, main memory includes random access memory (RAM) that communicates with one or more processors, e.g., central processing units (CPUs), over a memory bus. An in-memory database can be contrasted with database management systems that employ a disk storage mechanism. In some examples, in-memory databases are faster than disk storage databases, because internal optimization algorithms can be simpler and execute fewer CPU instructions, e.g., require reduced CPU consumption. In some examples, accessing data in an in-memory database eliminates seek time when querying the data, which provides faster and more predictable performance than disk-storage databases.

In some examples, one or more applications can be hosted by the server system 104. A user 110 can interact with an application using the client device 102. More specifically, a session can be established between the client device 102 and one or more server devices 108, during which session the user 110 is able to interact with one or more applications hosted on the server system 104. The one or more applications can enable the user to interact with data stored in one or more databases. In some examples, interactions can result in data being stored to the database, deleted from the database, and/or edited within the database.

In some implementations, the server system 104 hosts an intelligent airfare prediction platform in accordance with implementations of the present disclosure. In some examples, the intelligent airfare prediction platform is provided as a stand-alone service that interacts with a travel booking platform (e.g., also hosted by the server system 104). In some examples, the intelligent airfare prediction platform is part of a travel booking platform (e.g., also hosted by the server system 104). As described in further detail herein, the intelligent airfare prediction platform of the present disclosure provides forecasts of costs of airfare for routes from target dates (e.g., current date) to departure dates. For example, the user 110 is able to make a prediction request with itinerary information of a target flight by interacting with the client device 102. In some examples, a browser executed on the client device 102 is able to establish a session with the server system 104 and transmit the prediction request to the server system 104. When the intelligent airfare prediction platform on the server system 104 receives the prediction request, the intelligent airfare prediction platform can execute a prediction based on itinerary information included in the prediction request to provide a prediction result. The prediction result can include a set of predicted costs of the airfare and can be sent back to the client device 102 for display to the user 110 by a UI of the browser.

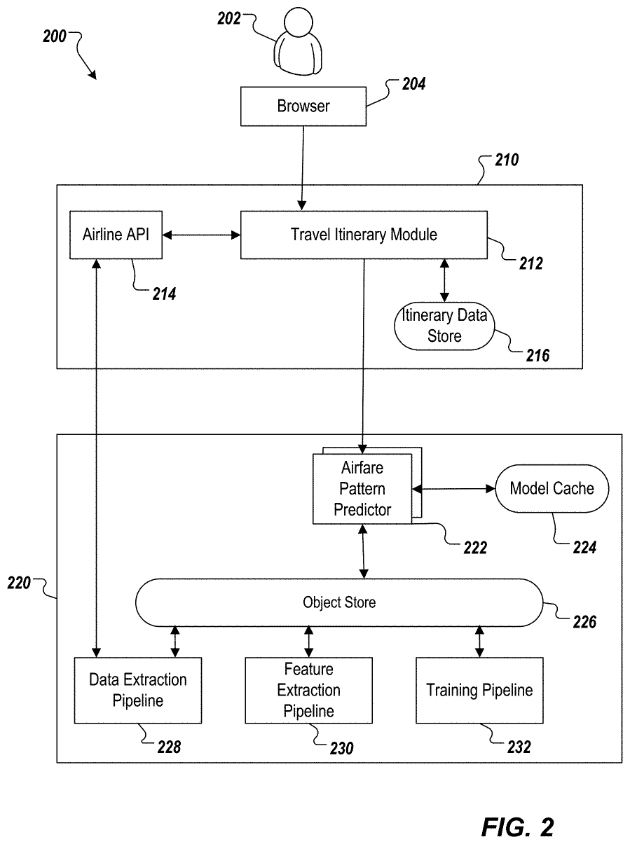

FIG. 2 depicts a conceptual architecture 200 in accordance with implementations of the present disclosure. In the example of FIG. 2, the example architecture 200 includes a browser 204, a travel management system 210, and a ML system 220. In some examples, at least portions of each of the travel management system 210, and/or the ML system 220 provide the intelligent airfare prediction platform of the present disclosure.

In some implementations, the browser 204 can be executed by a client device (e.g., the client device 102 of FIG. 1) to enable a user 202 (e.g., the user 110 of FIG. 1) to interact with the intelligent airfare prediction platform. In some examples, the travel management system 210 and the ML system 220 are each hosted by one or more server systems (e.g., the server system 104). An example travel management system includes, without limitation, SAP Concur provided by SAP SE of Walldorf, Germany. An example ML system can be provisioned within, and without limitation, a Cloud Foundry runtime executing within the SAP Cloud Platform provided by SAP SE. In the example of FIG. 2, the travel management system 210 includes a travel itinerary module 212, one or more airline APIs 214, and an itinerary data store 216. Also, in the example of FIG. 2, the ML system 220 includes one or more airfare pattern predictors 222, a model cache 224, an object store 226, a data extraction pipeline 228, a feature extraction pipeline 230, and a training pipeline 232.

In some examples, a training phase can include data extraction, data preparation, and training of one or more ML models. In some examples, the data extraction pipeline 228 periodically (e.g., daily) collects data representative of flight itineraries of different routes through the one or more airline APIs 214 and stores the data in the object store 226. For example, each airline API 214 can be connected to a ticket booking system or servers of a respective airline to request and receive data representative of flight itineraries. In some examples, each request to an airline API 214 includes a departure airport, an arrival airport, and a date. In some examples, the data can be extracted for any specific route, flight, departure date, and a specific number of days before departure. For predicting the costs of airfares of an itinerary on the target departure day, the data extraction executed by the data extraction pipeline 228 is repeated until the object store 226 is stored with enough data for the target flight. For example, to have a prediction of cost of the airfare for each day in the next 90 days before the departure date, data is retrieved and stored in the object store 226 for the target flight for each day of the 90 days before the target departure date. It is contemplated, however, that data can be retrieved for more days than the number of days before the departure date (e.g., 120 days, 1 year, 2 years, etc.).

Table 1, below, provides an example of data that can be extracted for an example route. For example, the example data of Table 1 can be provided (e.g., to the data extraction pipeline 228 of FIG. 2) from one or more APIs (e.g., the APIs 214 of FIG. 2). In some examples, the example data is provided in response to each request of multiple requests, each request including a departure airport (source), an arrival airport (destination), and a date.

TABLE 1
Example Data Representative of Itineraries

| Carrier | | | | Carrier | Departure | Departure | Days Before |
|---|---|---|---|---|---|---|---|
| Code | Source | Destination | Price | No. | Date | Time | Departure |
| SQ | SIN | FRA | 1,626 | 26 | 2020 Aug. 13 | 23:55 | 1 |
| LH | SIN | FRA | 1,556 | 779 | 2020 Aug. 14 | 23:40 | 2 |
| SQ | SIN | FRA | 1,626 | 26 | 2020 Aug. 14 | 23:55 | 2 |
| SQ | SIN | FRA | 1,290 | 26 | 2020 Aug. 15 | 23:55 | 3 |
| LH | SIN | FRA | 906 | 779 | 2020 Aug. 16 | 23:40 | 4 |
| SQ | SIN | FRA | 1,290 | 26 | 2020 Aug. 16 | 23:55 | 4 |
| SQ | SIN | FRA | 852 | 26 | 2020 Aug. 18 | 23:55 | 6 |
| LH | SIN | FRA | 642 | 779 | 2020 Aug. 19 | 23:40 | 7 |
| SQ | SIN | FRA | 852 | 26 | 2020 Aug. 20 | 23:55 | 8 |
| LH | SIN | FRA | 528 | 779 | 2020 Aug. 21 | 23:40 | 9 |
| SQ | SIN | FRA | 852 | 26 | 2020 Aug. 21 | 23:55 | 9 |
| SQ | SIN | FRA | 852 | 26 | 2020 Aug. 22 | 23:55 | 10 |
| . . . | . . . | . . . | . . . | . . . | . . . | . . . | . . . |

In some examples, each of the airline APIs provides additional data (not depicted in Table 1). Example additional data can include, without limitation, stops (e.g., non-stop, multiple stops), itinerary type (e.g., one-way, return, multi-city), day of week (e.g., weekday, weekend), layover period(s), and aircraft type (e.g., Airbus A350, Airbus A340).

In the example of Table 1, requests are transmitted on Aug. 12, 2020 for each day of a number of days until departure (e.g., 90 days until departure). In the example of Table 1, data is absent for Aug. 17, 2021 (5 days before departure). Here, it can occur that there are no flights for the itinerary on that day.

While the example of Table 1 represents example data for an example itinerary (e.g., one-way, Singapore (SIN) to Frankfurt (FRA)), it is contemplated that data is extracted for each itinerary in a set of itineraries. This can be for tens, hundreds, even thousands of itineraries (e.g., SIN→FRA, FRA→SIN, SIN→HKG, HKG→SIN, FRA→HKG, HKG→FRA, . . . ). In some examples, to constrain a size of the datasets, the itineraries can be constrained. For example, an enterprise can be associated with multiple geographic locations and travel on behalf of the enterprise can typically occur between these locations (e.g., as opposed to other locations, at which the enterprise does not have a facility and/or a customer). For example, an example enterprise can include a headquarters at or near one location (e.g., Frankfurt) and a facility at or near other locations (e.g., Singapore, San Francisco, Philadelphia) and customers at or near other locations (e.g., London, Paris, Beijing). For the example enterprise, the itineraries can be constrained to flights between the headquarters and each of the other facility locations and between the headquarters and the other facility locations and each of the other customer locations. By constraining the number of itineraries, a number of ML models in the set of ML models can be likewise constrained. In this manner, the burden on technical resources, such as memory and processing, for training and maintaining the ML models can be reduced.

The extracted datasets are processed during so-called data preparation for subsequent training respective ML models (e.g., a ML model for each route). In some examples, data preparation is executed by the data extraction pipeline 228 of FIG. 2. As described in further detail herein, implementations of the present disclosure provide for data preparation that results reducing complexity of data representations that still capture patterns in price variations. This not only conserves resources (e.g., less memory and processing of simpler data representations than more complex), but also reduces the technical burden in training and maintaining ML models.

In some implementations, data preparation can include one or more of handling null values, encoding string values, encoding dates, and converting hours. In some examples, null values and string values may not be directly usable for training a ML model. Consequently, null values and string values can be converted into usable values. In some examples, null values are replaced with a predefined numerical value (e.g., zero). In some examples, strings (e.g., name of airline, source, destination, carrier code) are converted into numerical values. In some examples, encoding is performed using label encoding, which can include mapping string values to discrete numerical values. For example, label encoding can include a mapping table that defines a mapping between a string value and a respective numerical value. By way of non-limiting example, and for source or destination, the string value SIN can be mapped to 0, the string value FRA can be mapped to 1, the string value HKG can be mapped to 2, and so on. As another non-limiting example, weekdays can be mapped to 1 (or 0) and weekends can be mapped to 0 (or 1).

By using label encoding, the encoded values are more compact than other encoding techniques, such as, and without limitation, embeddings and one-hot encoding. For example, such other encoding techniques result in a multi-dimensional vector representative of each of the string value in an encoding space. These multi-dimensional vectors consume more memory and put a higher-demand on processing power (e.g., during training of a ML model, during generation of the multi-dimensional vectors) than do label encodings. Further, ML models trained using label encodings can be smaller and less complex than ML models trained on larger, more complex encodings, further reducing burden on memory and processing.

In some examples, the format of date (e.g., year/month/day) and time (e.g., hour:minute) as provided from the data extraction may not be as desired for training of a ML model. In some examples, date is divided into multiple values including, for example, a month value and a day value. For example, and without limitation, the date value of 2020 Aug. 13 can be processed to provide a month value of 8 and a day value of 13, the year being discarded. Here, dates are converted into multiple numerical values (e.g., float values). In some examples, time is converted to a single numerical value by mapping times to time ranges, each time range being represented by a numerical value. By way of non-limiting example, each departure time can be mapped to a departure hour range of a set of departure hour ranges, each departure hour range having a respective index value assigned there to. Table 2 provides an example mapping that can be used to map departure times to numerical values:

TABLE 2
Example Time Mapping

| Value | Departure Hour Range |
|---|---|
| 1 | 24-6 |
| 2 | 6-12 |
| 3 | 12-18 |
| 4 | 18-24 |

In the example of Table 2, a departure time of 23:55 is mapped to a numerical value of 4, a departure time of 14:36 is mapped to a numerical value of 3, and so forth. Here, the numerical values represent a general time of day, such as early morning, morning, afternoon, and evening. By mapping times to the numerical values, ML models trained on the numerical values are able to account for patterns of price variation that reflect the times of day. This enables improved accuracy over other techniques. For example, time ranges enable accounting of patterns depending on implicit traveler type (e.g., business travelers prefer day travel, whereas personal travelers prefer nighttime). Further, the numerical values are smaller and less complex than individual time values (e.g., 1 as opposed to 0543 (5:43 AM)), which reduces memory footprint in storing the numerical values and reduces processing power required to train each ML model. Further, ML models trained using such time encodings can be smaller and less complex than ML models trained on larger, more complex time values, further reducing burden on memory and processing.

While conversion and encoding of departure locations, carriers, dates, and times are discussed above, implementations of the present disclosure can also provide values for other parameters, which can be used for training of the ML models for improved accuracy in representing patterns in price variations. For example, weekdays can be encoded to a first value (e.g., 1) and weekends can be encoded to a second value (e.g., 0). As another example, weekdays of Monday-Thursday can be encoded to a first value (e.g., 0), Friday can be encoded to a second value (e.g., 1), Saturday can be encoded to a third value (e.g., 2), and Sunday can be encoded to a fourth value (e.g., 3). More fine granular encodings between days provides a distribution that improves accuracy.

Table 3 depicts example data that can be provided after data preparation:

TABLE 3
Example Prepared Data Representative of Itineraries

| | | Days Before | | Carrier | Departure | Departure | Departure |
|---|---|---|---|---|---|---|---|
| Carrier | Dest'n | Departure | Price | No. | Month | Day | Time |
| 9481 | 3 | 42 | 1012.0 | 18 | 5 | 31 | 1 |
| 12556 | 5 | 28 | 302.0 | 10 | 5 | 27 | 3 |
| 712 | 4 | 31 | 268.0 | 11 | 5 | 16 | 2 |
| 4595 | 0 | 23 | 1000.0 | 23 | 5 | 7 | 4 |
| 1618 | 4 | 51 | 496 | 16 | 6 | 7 | 2 |

In some implementations, the data extraction pipeline 228 stores the prepared data in the object store 226 for use in training ML models during the training phase.

In some implementations, a set of features is determined for subsequent training of the ML models. For example, the prepared data can include a superset of features, which can include features that are more relevant to predicting patterns in price variation and features that are less relevant to predicting patterns in price variation. In some examples, feature extraction can include identifying a set of features that is to be used for training the ML models. Here, the set of features can include all of the features of the superset of features (e.g., the set of features is identical to the superset of features and includes both less relevant and more relevant features), or the set of features can include fewer features than the features of the superset of features (e.g., the set of features is a sub-set of the superset of features and includes more relevant features). In some examples, the feature extraction pipeline 230 selects part or all of the features provided in the prepared data to be used for training of the ML models. Example features selected by the feature extraction pipeline 230 can be the combination of “source location,” “destination,” “days before departure,” “departure month,” “departure day,” and “departure hour range.”

In some implementations, the training pipeline 232 executes training of a ML model for each route (e.g., source—destination pair) to provide a set of ML models. In some examples, each ML model is provided as a regression model. An example regression model includes, without limitation, the random forest regressor. In general, random forests (also referred to as random decision forests) can be described as an ensemble learning technique for, among other tasks, regression, and includes iterative construction of a multitude of decision trees during training and outputting a mean (or average) prediction (regression) of individual trees. In some examples, training is performed using a loss function, an example loss function including, without limitation, root mean square error (RMSE). The loss function enables the accuracy of each ML model to be evaluated during training.

In general, a ML model is iteratively trained, where, during an iteration, one or more parameters of the ML model are adjusted, and an output is generated based on the training data (i.e., the prepared data). For each iteration, a loss value is determined based on a loss function (e.g., RMSE). The loss value represents a degree of accuracy of the output of the ML model. The loss value can be described as a representation of a degree of difference between the output of the ML model and an expected output of the ML model (the expected output being provided from training data). In some examples, if the loss value does not meet an expected value (e.g., is not equal to zero), parameters of the ML model are adjusted in another iteration of training. In some instances, this process is repeated until the loss value meets the expected value.

In accordance with implementations of the present disclosure, data is extracted and ML models are trained on a periodic basis. For example, and in the context of flights, the periodic basis is daily. That is, for each period, data is extracted and prepared, and training is executed on the prepared data. In some examples, the data that is extracted for a period is incremental. For example, the data includes data that is newly available for the period. In some examples, previously extracted data is dropped. For example, and without limitation, a first set of ML models is trained on data provided for a first set of days, d₁, . . . , dₙ, where n represents the number of days before a departure date (e.g., n=90). On the next day, a second set of ML models is trained on data provided for a second set of days, d₂, . . . , dₙ₊₁. Here, data for the day dₙ₊₁ is accounted for in the training, while data for the day d₁ is dropped from the training.

After the set of ML models has been trained, the set of ML models can be made available for inferencing during an inference phase. In general, inferencing can be described as providing input to a ML model, which processes the input to provide an output. In accordance with implementations of the present disclosure, input to the ML model can include an itinerary and output includes a set of prices, each price in the set of prices corresponding to a respective day before departure.

In some implementations, for inferencing, the browser 204 can receive a prediction request from the user 202 through a UI of the browser 204. In some examples, the prediction request includes itinerary information regarding the target flight that is searched by the user 202. Example itinerary information can include, without limitation, departure date, return date, itinerary type, source (departure airport), and destination (arrival airport). In some examples, the prediction request is transmitted to the travel itinerary module 212 of the travel management system 210.

In some examples, the travel management system 210 is provided as a Representational State Transfer (REST) application, which can receive the prediction request including the itinerary information as part of a hypertext transfer protocol (HTTP) request. In some examples, in response to receiving the prediction request, the travel itinerary module 212 can issue a query to collect additional information on available flights through the airline API 214. For example, the travel itinerary module 212 is able to derive the source, the destination, the departure time and the name of the carrier based only on the flight number included in the itinerary information. After deriving information from the airline API 214, the travel itinerary module 212 can send all the information to airfare pattern predictor 222.

In some implementations, upon receiving the information, the airfare pattern predictor 222 can identify the route (e.g., source—destination pair) of the target flight from the received information. In some examples, the airfare pattern predictor 222 selects a ML model from the set of ML models based on the route. For example, the set of ML models is stored in the model cache 224 and can be indexed based on route to return the ML model that is specific to the prediction request. The airfare pattern predictor 222 can execute the ML model by inputting at least a portion of the itinerary information (and at least a portion of the additional information) into the ML model. The ML model processes the input and provides output that includes a set of prices, each price corresponding to a respective day before departure. In some examples, the set of prices of the target flight can be displayed to the user 202 through a UI of the browser 204, which may enable the user to understand the price variation of the target flight intuitively.

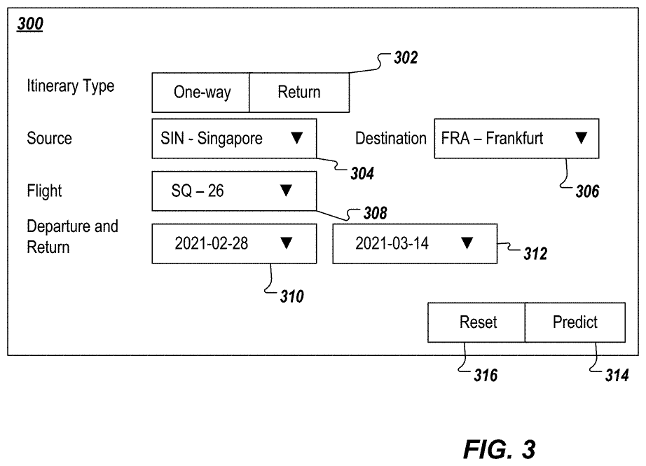

FIG. 3 depicts an example UI 300 that receives prediction requests from users in accordance with implementations of the present disclosure. In the example of FIG. 3, the example UI 300 includes buttons and drop-down menus for the user to enter the itinerary information. For example, the user can click on the itinerary type buttons 302 to make a selection regarding whether the target flight is a one-way flight or a return flight. The source and destination of the target flight can also be set through the drop-down menus 304 and 306. Flight number of the target flight can set through the drop-down menus 308. In some examples, the user only needs to enter either one of source/destination and flight number. After the departure date (and maybe also the return date) is chosen through drop-down menus 310 and 312, the user can decide to send out the request with the entered/selected itinerary information or reset the content by clicking on the buttons 314, 316, respectively.

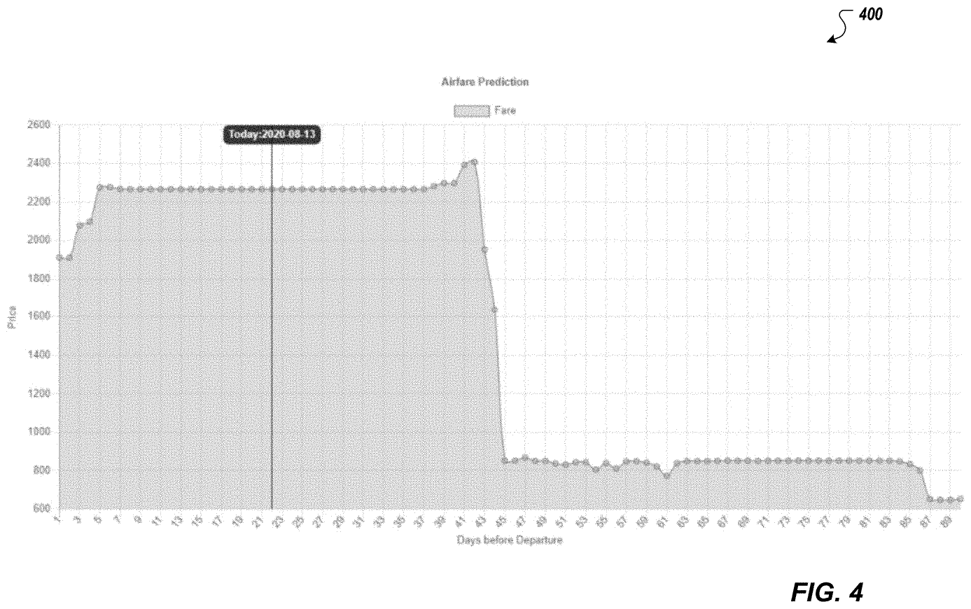

FIG. 4 depicts an example graph 400 representing the set of prices of the target flight to be displayed on the UI to the user. From the example graph 400, the price variations of the target flight from 90 days before the target departure date can be shown. It can be understood by the user that, today, the time has already passed to buy the best-priced ticket on the target flight. Further, the user can get the idea of the need of buying the ticket at least 45 days before the departure date, as the price of the target flight will become drastically high. In the example of FIG. 4, the user is querying the flight only 22 days before the departure date. Consequently, the user can decide whether to change departure dates (e.g., select a flight that is 23 days or more further into the future to obtain a lower cost) or wait to purchase the flight 2 days before departure, when the price is predicted to somewhat drop again.

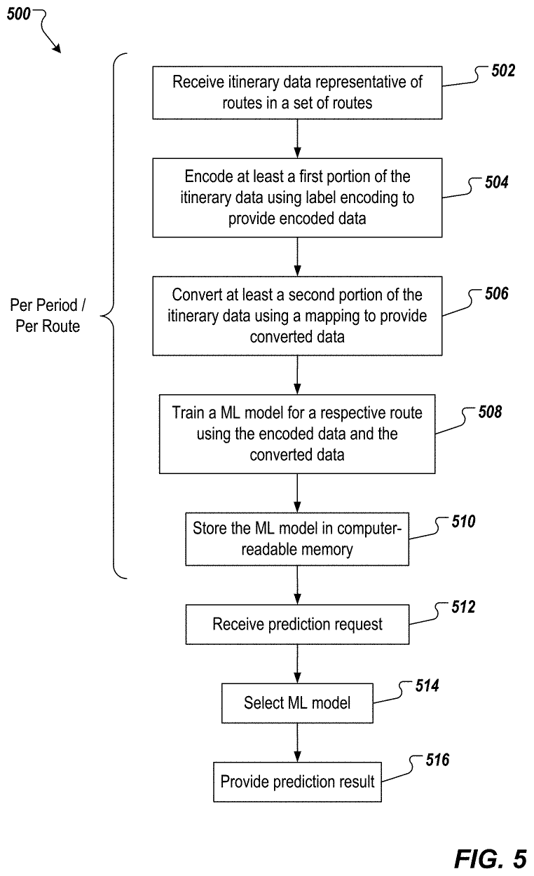

FIG. 5 depicts an example process 500 that can be executed in accordance with implementations of the present disclosure. In some examples, the example process 500 is provided using one or more computer-executable programs executed by one or more computing devices. The example process 500 is executed for providing predicted cost of airfare using a set of ML models.

Itinerary data representative of routes in a set of routes is received (502). For example, and as described herein, the intelligent airfare prediction platform of the present disclosure periodically retrieves itinerary data for respective routes in a set of routes through one or more airline APIs. In some examples, the itinerary data is representative of a selected number of days before a departure date associated with each route in the set of routes.

At least a first portion of the itinerary data is encoded using label encoding to provide encoded data (504). In some examples, encoding at least a first portion of the itinerary data using label encoding to provide encoded data includes mapping string values to numerical values, the string values comprising one or more of names of airlines, a source, a destination, and carrier codes. For example, and as described herein, strings (e.g., name of airline, source, destination, carrier code) are converted into numerical values. In some examples, label encoding can include a mapping table that defines a mapping between a string value and a respective numerical value. By way of non-limiting example, and for source or destination, the string value SIN can be mapped to 0, the string value FRA can be mapped to 1, the string value HKG can be mapped to 2, and so on. As another non-limiting example, weekdays can be mapped to 1 (or 0) and weekends can be mapped to 0 (or 1).

At least a second portion of the itinerary data is converted using a mapping to provide converted data (506). In some examples, the mapping comprises a set of time ranges, each time range associated with a numerical value, and converting at least a second portion of the itinerary data using a mapping to provide converted data includes, for each time in the second portion: mapping the time to a time range, identifying a numerical value associated with the time range, and including the numerical value in the converted data. For example, and as described herein, time is converted to a single numerical value by mapping times to time ranges, each time range being represented by a numerical value. By way of non-limiting example, each departure time can be mapped to a departure hour range of a set of departure hour ranges, each departure hour range having a respective index value assigned there to.

A ML model for a respective route is trained using the encoded data and the converted data (508). In some examples, each ML model in the set of ML models is a random forest regression model that is trained using a RMSE function. For example, and as described herein, the ML model is iteratively trained, where, during an iteration, one or more parameters of the ML model are adjusted, and an output is generated based on the training data (i.e., the prepared data). For each iteration, a loss value is determined based on a loss function (e.g., RMSE), and the training process is repeated until the loss value meets an expected value. The (trained) ML model is stored in computer-readable memory (510).

A prediction request is received (512). For example, and as described herein, a user can submit a prediction request that is received by the intelligent airfare prediction platform. A ML model is selected (514). For example, and as described herein, a route is determined from the prediction request and the ML model associated with the route is selected from the set of ML models. A prediction result is provided (516). For example, and as described herein, a prediction result is generated by processing at least a portion of the data representative of the route and the departure date through the ML model. In some examples, the prediction result includes a set of price-day pairs, each price-day pair including a price of airfare and a number of days before the departure date.

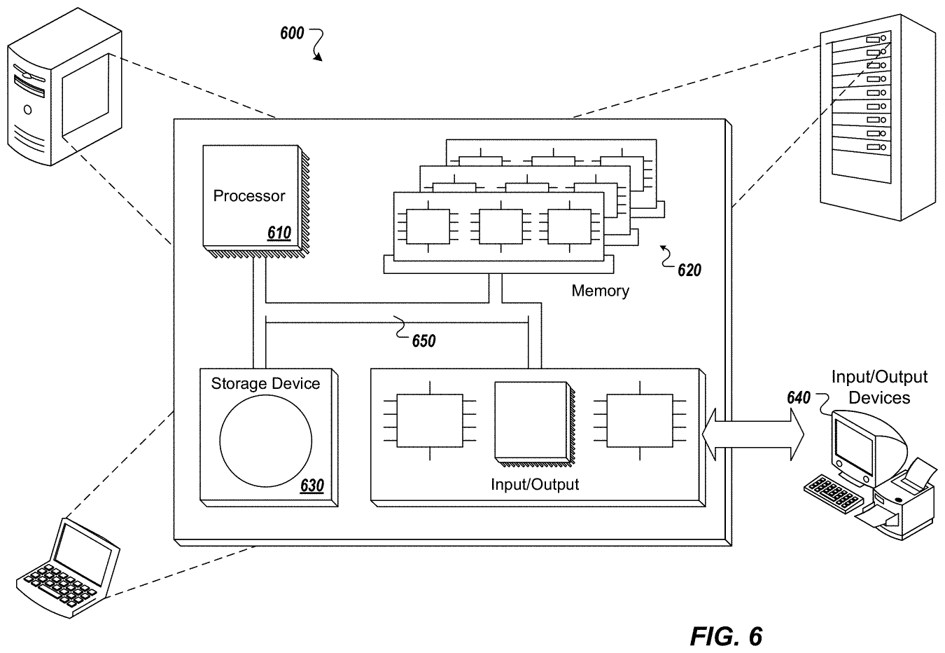

Referring now to FIG. 6, a schematic diagram of an example computing system 800 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for providing prediction of airfares of a target departure date using a set of machine learning (ML) models, the method comprising:
periodically receiving itinerary data representative of routes in a set of routes, the itinerary data comprising date data, price data, and route data;
for each period and each route in the set of routes:
encoding at least a first portion of the itinerary data using label encoding to provide encoded data, the first portion of the itinerary data comprising letters, the encoded data comprising one or more numbers and being absent of letters,
converting at least a second portion of the itinerary data using a mapping to provide converted data, the converted data comprising a number,
training a ML model for a respective route using the encoded data and the converted data, and
storing the ML model in computer-readable memory, the set of ML models comprising the ML model;
receiving a prediction request comprising data representative of a route and a departure date;
retrieving a ML model associated with the route from the computer-readable memory; and
generating a prediction result by processing at least a portion of the data representative of the route and the departure date through the ML model, the prediction result comprising a set of price-day pairs, each price-day pair comprising a price of airfare and a number of days before the departure date.

2. The computer-implemented method of claim 1, wherein encoding at least a first portion of the itinerary data using label encoding to provide encoded data comprises mapping string values to numerical values, the string values comprising one or more of names of airlines, a source, a destination, and carrier codes.

3. The method of claim 1, wherein the mapping comprises a set of time ranges, each time range associated with a numerical value, and converting at least a second portion of the itinerary data using a mapping to provide converted data comprises, for each time in the second portion:
mapping the time to a time range,
identifying a numerical value associated with the time range, and
including the numerical value in the converted data.

4. The method of claim 1, further comprising converting each null value in the itinerary data to zero.

5. The method of claim 1, wherein the itinerary data is representative of a selected number of days before a departure date associated with each route in the set of routes.

6. The method of claim 1, wherein each ML model in the set of ML models is a random forest regression model that is trained using a root mean square error (RMSE) function.

7. The method of claim 1, wherein the itinerary data is retrieved through one or more application programming interfaces (APIs), each API associated with a respective airline.

8. A non-transitory computer-readable storage medium coupled to one or more processors and having instructions stored thereon which, when executed by the one or more processors, cause the one or more processors to perform operations for providing prediction of airfares of a target departure date using a set of machine learning models, the operations comprising:
periodically receiving itinerary data representative of routes in a set of routes, the itinerary data comprising date data, price data, and route data;
for each period and each route in the set of routes:
encoding at least a first portion of the itinerary data using label encoding to provide encoded data, the first portion of the itinerary data comprising letters, the encoded data comprising one or more numbers and being absent of letters,
converting at least a second portion of the itinerary data using a mapping to provide converted data, the converted data comprising a number,
training a ML model for a respective route using the encoded data and the converted data, and
storing the ML model in computer-readable memory, the set of ML models comprising the ML model;
receiving a prediction request comprising data representative of a route and a departure date;
retrieving a ML model associated with the route from the computer-readable memory; and
generating a prediction result by processing at least a portion of the data representative of the route and the departure date through the ML model, the prediction result comprising a set of price-day pairs, each price-day pair comprising a price of airfare and a number of days before the departure date.

9. The non-transitory computer-readable storage medium of claim 8, wherein encoding at least a first portion of the itinerary data using label encoding to provide encoded data comprises mapping string values to numerical values, the string values comprising one or more of names of airlines, a source, a destination, and carrier codes.

10. The non-transitory computer-readable storage medium of claim 8, wherein the mapping comprises a set of time ranges, each time range associated with a numerical value, and converting at least a second portion of the itinerary data using a mapping to provide converted data comprises, for each time in the second portion:
mapping the time to a time range,
identifying a numerical value associated with the time range, and
including the numerical value in the converted data.

11. The non-transitory computer-readable storage medium of claim 8, wherein operations further comprise converting each null value in the itinerary data to zero.

12. The non-transitory computer-readable storage medium of claim 8, wherein the itinerary data is representative of a selected number of days before a departure date associated with each route in the set of routes.

13. The non-transitory computer-readable storage medium of claim 8, wherein each ML model in the set of ML models is a random forest regression model that is trained using a root mean square error (RMSE) function.

14. The non-transitory computer-readable storage medium of claim 8, wherein the itinerary data is retrieved through one or more application programming interfaces (APIs), each API associated with a respective airline.

15. A system, comprising:
a computing device; and
a computer-readable storage device coupled to the computing device and having instructions stored thereon which, when executed by the computing device, cause the computing device to perform operations providing prediction of airfares of a target departure date using a set of machine learning models, the operations comprising:
periodically receiving itinerary data representative of routes in a set of routes, the itinerary data comprising date data, price data, and route data;
for each period and each route in the set of routes:
encoding at least a first portion of the itinerary data using label encoding to provide encoded data, the first portion of the itinerary data comprising letters, the encoded data comprising one or more numbers and being absent of letters,
converting at least a second portion of the itinerary data using a mapping to provide converted data, the converted data comprising a number,
training a ML model for a respective route using the encoded data and the converted data, and
storing the ML model in computer-readable memory, the set of ML models comprising the ML model;
receiving a prediction request comprising data representative of a route and a departure date;
retrieving a ML model associated with the route from the computer-readable memory; and
generating a prediction result by processing at least a portion of the data representative of the route and the departure date through the ML model, the prediction result comprising a set of price-day pairs, each price-day pair comprising a price of airfare and a number of days before the departure date.

16. The system of claim 15, wherein encoding at least a first portion of the itinerary data using label encoding to provide encoded data comprises mapping string values to numerical values, the string values comprising one or more of names of airlines, a source, a destination, and carrier codes.

17. The system of claim 15, wherein the mapping comprises a set of time ranges, each time range associated with a numerical value, and converting at least a second portion of the itinerary data using a mapping to provide converted data comprises, for each time in the second portion:
mapping the time to a time range,
identifying a numerical value associated with the time range, and
including the numerical value in the converted data.

18. The system of claim 15, wherein operations further comprise converting each null value in the itinerary data to zero.

19. The system of claim 15, wherein the itinerary data is representative of a selected number of days before a departure date associated with each route in the set of routes.

20. The system of claim 15, wherein each ML model in the set of ML models is a random forest regression model that is trained using a root mean square error (RMSE) function.
